(19) United States
(12) Patent Application Publication
(10) Pub. No.: US 2013/0208449 A1
(43) Pub. Date: Aug. 15, 2013

(54) LIGHTING DEVICE AND DISPLAY DEVICE

(71) Applicant: Toshikazu Matsukawa, Osaka (JP)

(72) Inventor: Toshikazu Matsukawa, Osaka (JP)

(73) Assignee: SHARP KABUSHIKI KAISHA, Osaka (JP)

(21) Appl. No.: 13/879,465

(22) PCT Filed: Oct. 14, 2011
(86) PCT No.: PCT/JP2011/073667

§ 371 Date: Apr. 22, 2013

(30) Foreign Application Priority Data
Oct. 22, 2010 (JP) 2010-237036

(51) Int. Cl. F21V 21/14; G09F 13/04

(52) U.S. Cl. CPC F21V 21/14; G09F 13/0413
USPC 362/97.1; 362/372

(57) ABSTRACT

Provided is an illumination device that can continuously dissipate heat generated by a light source in an excellent manner. The illumination device includes LED substrates 26 and a back chassis 21 that has a bottom 21a to which the LED substrate 26 is to be installed. Guide grooves 27 that extend in the X direction are provided on the bottom 21a. By fitting the LED substrates 26 into the guide grooves 27, the LED substrates 26 are installed on the bottom 21a.

### TECHNICAL FIELD

The present invention relates to an illumination device and a display device.

### BACKGROUND ART

In a liquid crystal display device, which is a type of display device, the liquid crystal display panel that displays images is non-light-emitting, and thus, an illumination device is disposed on the rear side of the liquid crystal display panel (the side of the liquid crystal display panel opposite to the display surface side), and the liquid crystal display panel is illuminated by light from the illumination device. The illumination device disposed on the rear side of the liquid crystal display panel is referred to as a backlight unit or the like, for example.

A cold cathode fluorescent lamp in which mercury or xenon is sealed inside a fluorescent tube is known as a light source used in the backlight unit. However, if a cold cathode fluorescent lamp is used as the light source for the backlight unit, the brightness and longevity thereof are insufficient, and in addition, it is difficult to have the light emitted evenly due to the fact that the brightness in the low voltage side is low. In order to solve such problems, various backlight units that use an LED (light emitting diode) package as the light source instead of the cold cathode fluorescent lamp have been proposed.

There are two main types of backlight units: an edge light type; and a direct light type.

In an edge light type backlight unit, a light guide plate is disposed directly under a liquid crystal display panel (the region facing the rear surface of the liquid crystal display panel), and a light source is disposed facing a prescribed side face of the light guide plate. In the edge light backlight unit, when light is emitted from the light source, light from the light source enters the light guide plate through the prescribed side face of the light guide plate. The liquid crystal display panel is illuminated by light, which has entered the light guide plate, being emitted from the front surface of the light guide plate (the surface facing the liquid crystal display panel).

On the other hand, in a direct light backlight unit, the light source is disposed directly under the liquid crystal display panel. Such a direct light backlight unit has an advantage in terms of illuminating a large area with a large output, and is often used in a large liquid crystal display device. Patent Document 1, for example, discloses a direct light backlight unit with an LED package as the light source.

In general, as shown in FIG. 9, an LED package 101 is mounted on an LED substrate 102. The LED substrate 102 on which the LED package 101 is mounted is fastened to a back chassis 104 that also functions as a heat dissipating member by fastening members 103 such as rivets or screws. In this configuration, if the LED package 101 emits heat, the heat from the LED package 101 is transferred to the back chassis 104 from the LED substrate 102, and then dissipated.

### RELATED ART DOCUMENT

### Patent Document

Patent Document 1: Japanese Patent Application Laid-Open Publication No. 2009-158193

### SUMMARY OF THE INVENTION

### Problems to be Solved by the Invention

However, if the LED substrate 102 is fastened to the back chassis 104, then if the LED substrate 102 undergoes thermal expansion, then as shown in FIG. 10, the LED substrate 102 warps away from the back chassis 104. In other words, the LED substrate 102 separates far from the back chassis 104. As a result, heat transfer from the LED substrate 102 to the back chassis 104 is decreased, and it becomes difficult to dissipate heat emitted by the LED package 101 mounted on the LED substrate 102 in an excellent manner.

The present invention aims to solve the above-mentioned problems, and an object thereof is to provide an illumination device and a display device in which it is possible to continue to dissipate heat emitted from the light source in an excellent manner.

### Means for Solving the Problems

In order to accomplish the above-mentioned object, an illumination device according to a first aspect of the present invention includes: a light source substrate on which a light source is mounted; and a case that has a bottom with a bottom surface facing an object to be illuminated, the case having the light source substrate installed on the bottom thereof. A rail shaped guide groove having a slit is provided on the bottom of the case, the guide groove extending in a prescribed direction parallel to the bottom surface of the case, and the light source substrate is inserted in the guide groove, thereby installing the light source substrate on the bottom of the case.

In the illumination device according to the first aspect, as stated above, the rail shaped guide groove that has a slit is provided on the bottom of the case extending along a prescribed direction (one of the directions parallel to the bottom surface of the case), and by inserting the light source substrate inside the guide groove, it is possible to install the light source substrate on the bottom of the case without fastening the light source substrate on the bottom of the case using a fastening member (a rivet or a screw, for example). As a result, even if the light source substrate undergoes thermal expansion, it is possible for the light source substrate to expand in a prescribed direction, which is the direction that the guide groove extends, and thus, the light source substrate is not susceptible to warping in a direction away from the bottom of the case (a direction perpendicular to the bottom surface of the case). In other words, the light source substrate does not separate much from the bottom of the case. Therefore, a decrease in heat transfer from the light source substrate to the bottom of the case is mitigated, and it is therefore possible to continue to dissipate heat from the light source mounted on the light source substrate in an excellent manner.

In addition, with this configuration, the light source substrate is not fastened to the bottom of the case, and therefore, if the light source substrate needs to be replaced for any reason, it is easier to remove the light source substrate.

It is preferable that in the illumination device according to the first aspect, the light source substrate be inserted in the guide groove such that the light source protrudes through the slit of the guide groove. With this configuration, even if the light source substrate is inserted inside the guide groove, when light is emitted from the light source mounted on the light source substrate, the light emitted from the light source is not blocked by the guide groove.

In the configuration in which the light source protrudes from the slit of the guide groove, it is preferable that a periphery of a part of the light source substrate where the light source is mounted be pressed by edges of the slit of the guide groove. With this configuration, it is possible to install the light source substrate on the bottom of the case with ease. The mounting surface of the light source substrate (surface where the light source is mounted) and the rear surface (surface opposite to the mounting surface) are both in contact directly or indirectly with the bottom of the case, and therefore, heat emitted by the light source mounted on the light source substrate is efficiently dissipated. In addition, if the light source substrate thermally expands in the plate thickness direction, the periphery of the part of the light source substrate where the light source is mounted and the edges of the slit of the guide groove are in closer contact with each other, thus further increasing the heat dissipating effect.

In the illumination device according to the first aspect, it is preferable that the guide groove extend from one end of the bottom of the case to another end thereof in the prescribed direction. If the light source substrate is inserted evenly inside such a guide groove, then it is possible to dispose the light source substrate (light source) along the entire region from the one end to the other end of the bottom of the case with ease.

In the configuration in which the guide groove extends from one end to another end in a prescribed direction of the bottom of the case, it is preferable that an insertion hole for inserting the light source substrate into the guide groove be provided on an end of the guide groove located on at least one end in the prescribed direction of the bottom of the case. With this configuration, by inserting the light source substrate in the insertion hole of the guide groove and sliding it in a prescribed direction, it is possible to insert the light source substrate inside the guide groove with ease.

In this case, the insertion hole may also be provided on an end of the guide groove located on another end in the prescribed direction of the bottom of the case. With this configuration, when two light source substrates are to be arranged along a prescribed direction, for example, it is possible to align two light source substrates in a prescribed direction with ease.

Also, in the configuration in which an insertion hole is provided in an end of the guide groove located on at least one end in a prescribed direction on the bottom of the case, a case may be disposed such that one end in the prescribed direction of the bottom of the case is located on top and another end in the prescribed direction of the bottom of the case is located on the bottom, and the end of the guide groove located on the aforementioned another end of the bottom of the case in the prescribed direction may be closed. With this configuration, the light source substrate inserted in the guide groove constantly has a downward force acting upon it due to gravity, and thus, even if some vibration occurs, the light source substrate does not move.

In the illumination device according to the first aspect, it is preferable that the guide groove be formed integrally on the bottom of the case. With this configuration, there is no need to prepare a separate member that has a guide groove, thus reducing the number of parts.

A display device according to a second aspect of the present invention includes: the illumination device according to the first aspect; and a display panel illuminated by light from the illumination device.

In the display device configured in this way, it is possible to continue to dissipate heat from the light source mounted on the light source substrate in an excellent manner.

### Effects of the Invention

As stated above, according to the present invention, it is possible to obtain an illumination device and a display device that can continue to dissipate heat from a light source in an excellent manner.

### BRIEF DESCRIPTION OF THE DRAWINGS

FIG. 1 is an exploded perspective view of a liquid crystal display device (display device) that includes a backlight unit (illumination device) according to Embodiment 1 of the present invention.

FIG. 2 is a cross-sectional view of a guide groove provided in a back chassis (case) of the backlight unit shown in FIG. 1.

FIG. 3 is a cross-sectional view that shows an LED substrate (light source substrate) inserted in the guide groove shown in FIG. 2.

FIG. 4 is a perspective view that shows a situation in which the LED substrates are removed from the guide grooves of the back chassis of the backlight unit shown in FIG. 1.

FIG. 5 is a simplified view that shows LED substrates inserted in guide grooves of a back chassis of a backlight unit in a modification example of Embodiment 1.

FIG. 6 is a simplified view that shows the LED substrates removed from the guide grooves shown in FIG. 5.

FIG. 7 is a perspective view of a back chassis of a backlight unit and guide grooves later attached to the back chassis according to Embodiment 2 of the present invention.

FIG. 8 is a perspective view of a back chassis of a backlight unit and guide grooves later attached to the back chassis according to a modification example of Embodiment 2.

FIG. 9 is a simplified view that shows a situation in which an LED substrate is installed (fastened) to a back chassis of a conventional backlight unit.

FIG. 10 is a drawing for describing a problem of conventional devices.

### DETAILED DESCRIPTION OF EMBODIMENTS

### Embodiment 1

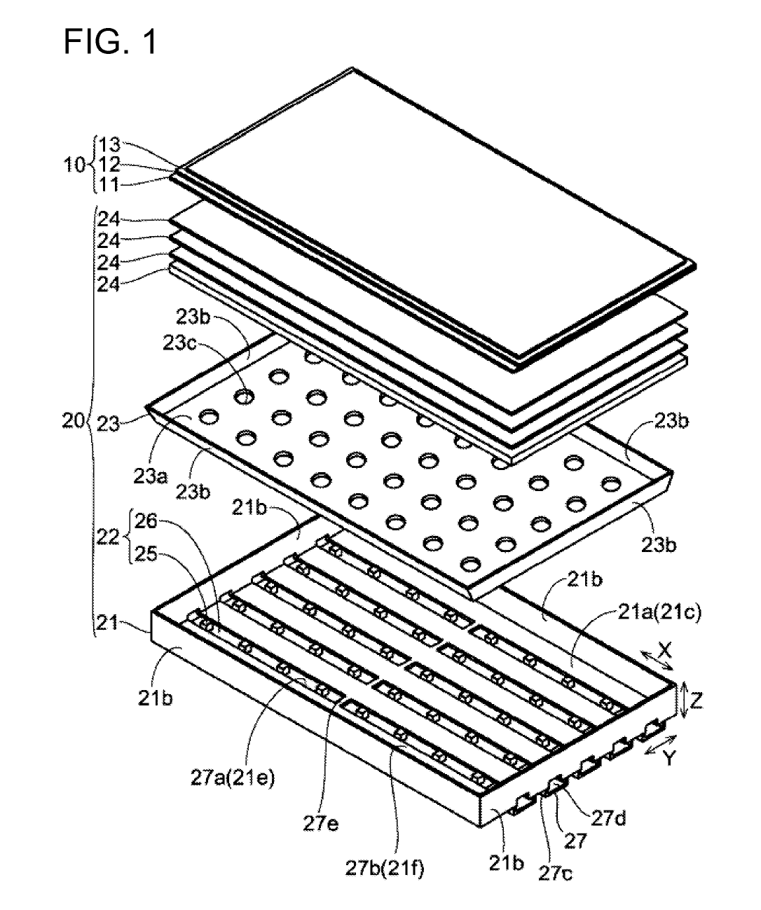

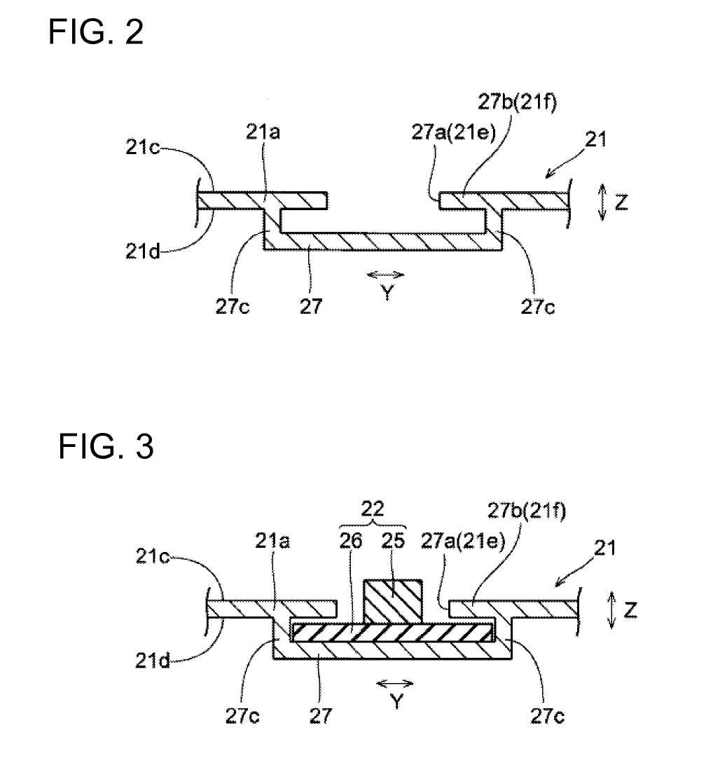

A configuration of a display device that includes an illumination device according to Embodiment 1 of the present invention will be described with reference to FIGS. 1 to 4.

The display device is a liquid crystal display device, and as shown in FIG. 1, includes at least a liquid crystal display panel (illuminated body) 10 that displays images, and a backlight unit 20 disposed on the rear side of the liquid crystal display panel 10, which is a side opposite to a display surface side. The liquid crystal display panel 10 is one example of a “display panel” of the present invention, and the backlight unit 20 is one example of an “illumination device” of the present invention.

The liquid crystal display panel 10 has a display region that actually displays images, and a non-display region that is an outer edge region to the display region. The display region of the liquid crystal display panel 10 has a plurality of pixels formed therein in a matrix.

The plurality of pixels are respectively driven by switching elements, pixel electrodes, a common electrode, and the like. For ease of viewing, the switching elements, the pixel electrodes, and the common electrode are not shown in the drawings, and wiring lines and the like electrically connected thereto are not shown in the drawings either.

The switching element is made of a TFT (thin film transistor), and a gate of the switching element is connected to a gate line (scanning line), and a source of the switching element is connected to a source line (data line). A pixel electrode is connected to a drain of the switching element, a common electrode is disposed opposite to the pixel electrode, and liquid crystal (not shown in drawings) is sandwiched between the pixel electrode and the common electrode. A switching element is provided individually for each pixel, and a pixel electrode is provided individually for each pixel. However, the common electrode is common to all pixels as the name suggests.

The backlight unit 20 uses a direct light system and emits planar white light from the backlight, which illuminates the rear of the liquid crystal display panel 10 without any unevenness.

When conducting display, the optical characteristic (light transmittance) of the liquid crystal changes for each pixel based on an image signal. Specifically, a prescribed amount of power is supplied to the pixel electrode through the switching element for each pixel, which generates an electric field between the pixel electrode and the common electrode. As a result of the electric field generated between the pixel electrode and the common electrode, the orientation of the liquid crystal, or in other words, the transmittance of light through the liquid crystal is changed.

Thus, when the light from the backlight is emitted by the backlight unit 20 and the rear of the liquid crystal display panel 10 is illuminated by this light, the amount of light from the backlight that is transmitted through the liquid crystal display panel 10 is different for each pixel. As a result, a desired image is displayed on the display surface of the liquid crystal display panel 10.

The configuration of the liquid crystal display panel 10 and the backlight unit 20 is described in more detail below.

The liquid crystal display panel 10 includes at least two transparent substrates 11 and 12. One transparent substrate 11 is referred to as an active matrix substrate, and the other transparent substrate 12 is sometimes referred to as an opposite substrate due to being disposed opposite to the transparent substrate 11 or is sometimes referred to as a color filter substrate.

Switching elements and pixel electrodes are formed on a prescribed surface of the transparent substrate 11, and gate lines (scanning lines) and source lines (data lines) that are electrically connected thereto are also formed on the prescribed surface of the transparent substrate 11. A common electrode is formed on a prescribed surface of the transparent substrate 12. Also, in addition to the common electrode, color filters (not shown in drawings) are formed as necessary on the prescribed surface of the transparent substrate 12. The respective prescribed surfaces of the two transparent substrates 11 and 12 are covered by alignment films (not shown in drawings) that can orient the liquid crystal to a specific direction.

The two transparent substrates 11 and 12 are bonded to each other by a sealing member (not shown in drawing) such that the respective prescribed surfaces thereof face each other. Liquid crystal is sealed between the two transparent substrates 11 and 12. With this configuration, liquid crystal is sandwiched between the pixel electrodes and the common electrode (between an alignment film that covers a prescribed surface of the transparent substrate 11 and an alignment film that covers a prescribed surface of the transparent substrate 12).

In addition, the outer size is different between the two transparent substrates 11 and 12; the outer size of the transparent substrate 11 is greater than the outer size of the transparent substrate 12. Therefore, while the two transparent substrates 11 and 12 are bonded to each other, the prescribed edges of the respective transparent substrates 11 and 12 do not coincide, and a part of the prescribed surface of the transparent substrate 11 is not covered by the transparent substrate 12. The exposed part of the prescribed surface of the transparent substrate 11 is one region of the non-display region, and is used in order to electrically connect the transparent substrate 11 to drivers (not shown in drawings).

The sides opposite to the prescribed surfaces (surfaces on the liquid crystal side) of the respective two transparent substrates 11 and 12 are each provided with one polarizing sheet 13 that transmits only light waves in a specific oscillating direction. The transmission axes of the two polarizing sheets 13 are at approximately 90° to each other.

The backlight unit 20 disposed on the rear side of the liquid crystal display panel 10 includes at least a back chassis 21, light emitting modules 22, a reflective sheet 23, and optical sheets 24. The back chassis 21 is one example of a “case” of the present invention.

The back chassis 21 is formed in a substantially box shape in which the liquid crystal display panel 10 side thereof is open. In other words, the back chassis 21 has a bottom 21a that is substantially rectangular from a plan view (plan view from the liquid crystal display panel 10 side), and a side 21b that rises from the outer edge of the bottom 21a. The back chassis 21 is held such that the bottom surface 21c of the bottom 21a faces the liquid crystal display panel 10. The region surrounded by the bottom 21a and the side 21b of the back chassis 21 is the storage region.

The light emitting modules 22 are for generating light that is the basis of the light from the backlight, and are installed on the bottom 21a of the back chassis 21. As for how to install the light emitting modules 22 on the bottom 21a of the back chassis 21, details thereof will be described below.

By installing the light emitting modules 22 on the bottom 21a of the back chassis 21, when the backlight unit 20 is disposed on the rear side of the liquid crystal display panel 10, the light emitting modules 22 are disposed directly below the liquid crystal display panel 10 (in a region facing the rear side of the liquid crystal display panel 10).

The light emitting modules 22 are configured so as to have two or more LED packages 25, which emit white light, as light sources (dot shaped light sources), and the two or more LED packages 25 are mounted on the same mounting surface of the LED substrate (light source substrate) 26 formed in a thin line shape. The two or more LED packages 25 are of a top view type, and the light-emitting surfaces thereof face the liquid crystal display panel 10. In other words, the mounting surface of the LED substrate 26 faces the liquid crystal display panel 10.

There is no special limitation on the method for having white light be emitted from the LED packages 25, and the LED packages 25 may be a combination of a fluorescent material that converts blue light to yellow light and a blue LED element, or a combination of fluorescent materials that convert blue light to green light and red light, respectively, and a blue LED element. Additionally, the LED package 25 may include a combination of three types of LED elements: a blue LED element, a green LED element, and a red LED element.

The number of LED packages 25 mounted on the mounting surface of the same LED substrate 26 is not limited either, and may be changed depending on the application.

There are a plurality of light emitting modules 22 installed on the bottom 21a of the back chassis 21, and these plurality of light emitting modules 22 are arranged with a prescribed gap therebetween in two dimensions parallel to the bottom surface 21a of the back chassis 21: the X direction (parallel to the lengthwise direction of the bottom 21a of the back chassis 21); and the Y direction (parallel to the crosswise direction of the bottom 21a of the back chassis 21). In this state, the lengthwise direction of the LED substrate 26 and the X direction are the same, and the crosswise direction of the LED substrate 26 and the Y direction are the same.

The reflective sheet 23 is for reflecting light emitted from the LED packages 25 to the liquid crystal display panel 10 side, and is stored in the storage region of the back chassis 21. The reflective sheet 23 has a bottom 23a that is substantially rectangular from a plan view, and a side 23b that is disposed at an incline to the outer periphery of the bottom 23a.

In a state in which the reflective sheet 23 is stored in the storage region of the back chassis 21, the bottom 23a of the reflective sheet 23 is mounted on the bottom surface 21c of the back chassis 21. In other words, the bottom 23a of the reflective sheet 23 covers the bottom surface 21c of the back chassis 21 and covers the mounting surfaces of the LED substrates 26.

If the entire mounting surface of the LED substrate 26 is covered with the bottom 23a of the reflective sheet 23, the LED packages 25 mounted on the mounting surface of the LED substrate 26 would also be covered by the bottom 23a of the reflective sheet 23. As a result, light emitted by the LED package 25 would be blocked. Therefore, the bottom 23a of the reflective sheet 23 is provided with the same number of circular exposing holes 23c as the LED packages 25 in order to expose the LED packages 25 on the side of the liquid crystal display panel 10. One LED package 25 is exposed (protrudes through) on the liquid crystal display panel 10 side per exposing hole 23c of the reflective sheet 23.

The optical sheets 24 are a group of sheets that include a diffusion sheet (diffusion plate), a prism sheet, and the like, and are disposed so as to cover the opening in the back chassis 21. In other words, the optical sheets 24 are disposed on a side facing the bottom surface 21c of the back chassis 21, and as a result, cover the light emitting modules 22 from the liquid crystal display panel 10 side. Therefore, the light emitted from the LED packages 25 illuminates the rear side of the liquid crystal display panel 10 after being diffused, condensed, and the like by entering the optical sheets 24. The types or number of optical sheets 24 can be appropriately adjusted according to the application.

As shown in FIGS. 1 to 3, in Embodiment 1, rail shaped guide grooves 27 that have slits 27a are provided on the bottom 21a of the back chassis 21, and the LED substrates 26 are inserted inside the guide grooves 27, and thus, the light emitting modules 22 are installed on the bottom 21a of the back chassis 21. In other words, in Embodiment 1, the light emitting modules 22 are installed on the bottom 21a of the back chassis 21 without fastening the LED substrates 26 on the bottom 21a of the back chassis 21 with fastening members (rivets or screws, for example).

Specifically, the guide grooves 27 are narrow and extend along the X direction. In other words, the slits 27a of the guide grooves 27 are also narrow and extend along the X direction. The X direction, which is the extension direction of the guide grooves 27, corresponds to the “prescribed direction” of the present invention.

The guide groove 27 has a substantially squared-U shape from a cross-sectional view, and the inner space of the substantially squared-U shape is an insertion space where the LED substrate 26 is inserted. The substantially squared-U shape of the guide groove 27 is actually formed integrally with the rear surface (surface on the side opposite to the bottom surface 21c) 21d of the bottom 21a of the back chassis 21.

In addition, a prescribed part (a part corresponding to where the guide groove 27 is formed) of the bottom 21a of the back chassis 21 has a narrow hole 21e that extends along the X direction, and this hole 21e of the back chassis 21 is the slit 27a of the guide groove 27. The Y direction width of the slit 27a of the guide groove 27 is less than the Y direction opening width of the LED substrate 26, and is greater than the Y direction width of the LED package 25.

The LED substrate 26 is inserted into the guide groove 27 such that the LED packages 25 mounted on the mounting surface of the LED substrates 26 protrude through the slit 27a of the guide groove 27. With this configuration, the edges 27b of the slit 27a of the guide groove 27 (the edges 21f of the hole 21e of the back chassis 21) press both edges in the Y direction of the LED substrate 26 (periphery of the part of the LED substrate 26 where the LED packages 25 are mounted). In other words, as a result of the edges 27b of the slit 27a of the guide groove 27, Z direction movement of the LED substrate 27 (direction perpendicular to the bottom surface 21c of the back chassis 21) is mitigated. Of course, the movement of the LED substrate 26 in the Y direction is mitigated by sides 27c of the guide groove 27.

The guide grooves 27 extend in the X direction from one end of the bottom 21a of the back chassis 21 to the other end thereof. Insertion holes 27d for inserting the LED substrate 26 in the guide groove 27 are provided respectively for the end of the guide groove 27 located on one end in the X direction of the bottom 21a of the back chassis 21 and the end of the guide groove 27 located on the other end in the X direction of the bottom 21a of the back chassis 21. A middle portion of the guide groove 27 in the X direction is divided by a dividing part 27e.

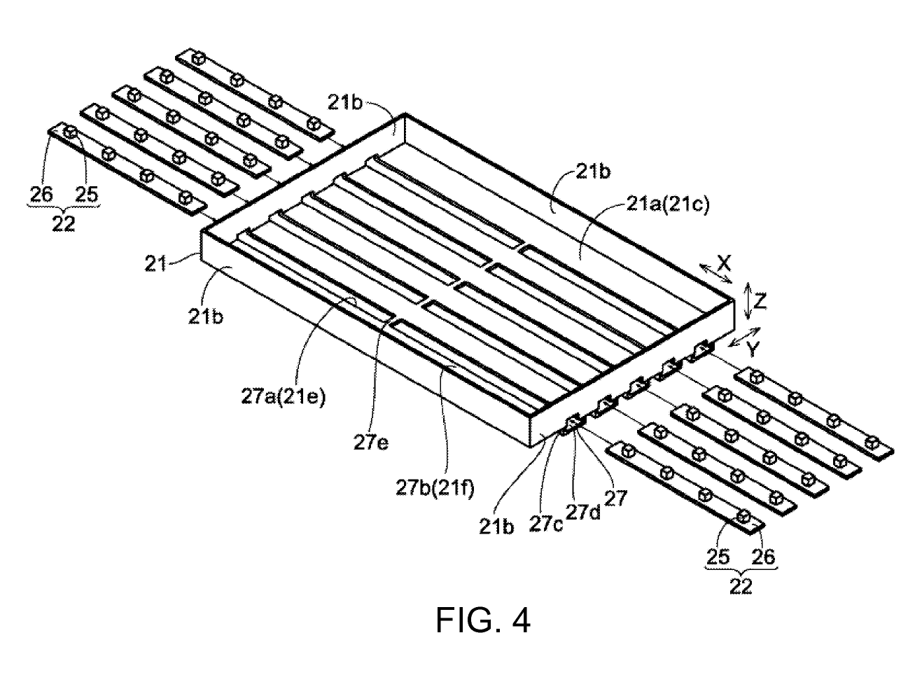

When inserting the LED substrate 26 in such a guide groove 27, the method shown in FIG. 4 may be used. Specifically, one group of the plurality of LED substrates 26 is inserted from the insertion hole 27d of the guide groove 27 located on one end in the X direction of the bottom 21a of the back chassis 21, and by sliding in the LED substrates 26 in the X direction, the LED substrates 26 are inserted into the guide groove 27. The other group of the plurality of LED substrates 26 is inserted from the insertion hole 27d of the guide groove 27 located on the other end in the X direction of the bottom 21a of the back chassis 21, and by sliding in the LED substrates 26 in the X direction, the LED substrates 26 are inserted into the guide groove 27. This results in the state shown in FIG. 1.

As stated above, in Embodiment 1, the rail shape guide grooves 27, which have the slits 27a, are provided on the bottom 21a of the back chassis 21 so as to extend in the X direction (one direction that is parallel to the bottom surface 21c of the back chassis 21), and by inserting the LED substrates 26 into the guide grooves 27, it is possible to install the LED substrates 26 on the bottom 21a of the back chassis 21 without fastening the LED substrates 26 on the bottom 21a of the back chassis 21 using a fastening member (a rivet or a screw, for example). Thus, even if the LED substrates 26 undergo thermal expansion, it is possible to direct the expansion of the LED substrates 26 towards the X direction, which is the direction in which the guide grooves 27 extend, and therefore, the LED substrates 26 are not susceptible to warping towards the Z direction away from the bottom 21a of the back chassis 21 (the direction perpendicular to the bottom surface 21c of the back chassis 21). In other words, the LED substrates 26 do not separate far from the bottom 21a of the back chassis 21. Therefore, a decrease in heat transfer from the LED substrates 26 to the bottom 21a of the back chassis 21 is mitigated, thus allowing heat generated by the LED packages 25 mounted on the mounting surfaces of the LED substrates 26 to continue to be dissipated in an excellent manner.

In addition, in Embodiment 1, the LED substrates 26 are not fastened onto the bottom 21a of the back chassis 21, and therefore, if an LED substrate 26 needs to be replaced for any reason, the LED substrate 26 can be removed with ease.

Also, as stated above, in Embodiment 1, the LED packages 25 protrude from the respective slits 27a of the guide grooves 27, and therefore, even if the LED substrates 26 are inserted into the guide grooves 27, when light is emitted from the LED packages 25, light emitted by the LED packages 25 is not blocked by the guide grooves 27.

Also, as stated above, in Embodiment 1, it is possible to install each LED substrate 26 reliably on the bottom 21a of the back chassis 21 with ease by pressing the periphery of the part of the LED substrate 26 where the LED packages 25 are mounted using the edges 27b of the slit 27a of the guide groove 27. Also, the bottom 21a of the back chassis 21 is directly or indirectly in contact with both the mounting surfaces of the LED substrates 26 and the rear surfaces opposite thereto, and therefore, heat generated by the LED packages 25 is efficiently dissipated. If an LED substrate 26 thermally expands in the plate thickness direction, the periphery of the part of the LED substrate 26 where the LED packages 25 are mounted is in closer contact to the edges 27b of the slit 27a of the guide groove 27, thus further increasing the heat dissipating effect.

As stated above, in Embodiment 1, the guide grooves 27 are extended from one end of the bottom 21a of the back chassis 21 to the other end thereof in the X direction. Therefore, by evenly inserting the LED substrates 26 into the guide grooves 27, it is possible to dispose the LED substrates 26 (LED packages 25) through the entire bottom 21a of the back chassis 21 from one end to the other, with ease.

As stated above, in Embodiment 1, the insertion holes 27d (holes for inserting the LED substrates 26 into the guide grooves 27) are respectively provided in the respective ends of the guide grooves 27 on one end in the X direction of the bottom 21a of the back chassis 21 and on the other end in the X direction of the bottom 21a of the back chassis 21. Therefore, by inserting the LED substrates 26 into the insertion holes 27d of the guide grooves 27 and sliding them in the X direction, it is possible to insert the LED substrates 26 into the guide grooves 27 with ease. In addition, in this case, it is possible to have two LED substrates 26 aligned in the X direction with ease.

As stated above, in Embodiment 1, by forming the guide grooves 27 integrally with the bottom 21a of the back chassis 21, there is no need to separately prepare a member that has the guide grooves 27, thus reducing the number of parts.

When the liquid crystal display device is built into a television set, the liquid crystal display device is often disposed vertically. Therefore, if the Y direction is the up and down direction, for example, then one end and the other end in the Y direction of the bottom 21b of the back chassis 21 are respectively located on the top and on the bottom.

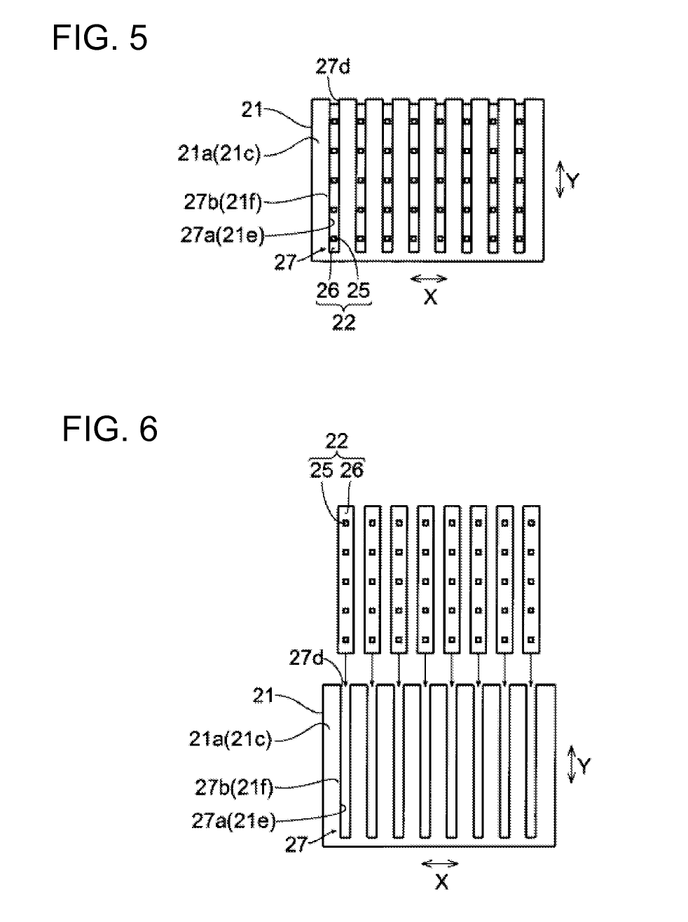

In this case, as shown in the modification examples in FIGS. 5 and 6, it is preferable that the guide grooves 27 be extended in the Y direction, that insertion holes 27d be provided on respective ends of the guide grooves 27 located on one end in the Y direction of the bottom 21a of the back chassis 21, and that respective ends of the guide grooves 27 on the other end in the Y direction of the bottom 21a of the back chassis 21 be closed. If the guide grooves 27 are extended in the Y direction, then the direction corresponding to the “prescribed direction” of the present invention is the Y direction.

The structure of the guide grooves 27 of the modification example of Embodiment 1 is similar to the structure of the guide grooves 27 of Embodiment 1 other than that the guide grooves 27 extend in the Y direction in the modification example. Other configurations in the modification example of Embodiment 1 are also similar to Embodiment 1.

In the modification example of Embodiment 1, by using the above-mentioned configuration, the LED substrates 26 inserted into the guide grooves 27 have a constant downward force acting upon them (towards the other end in the Y direction of the bottom 21a of the back chassis 21) due to gravity, and therefore, even with some vibration, the LED substrates 26 do not shift.

### Embodiment 2

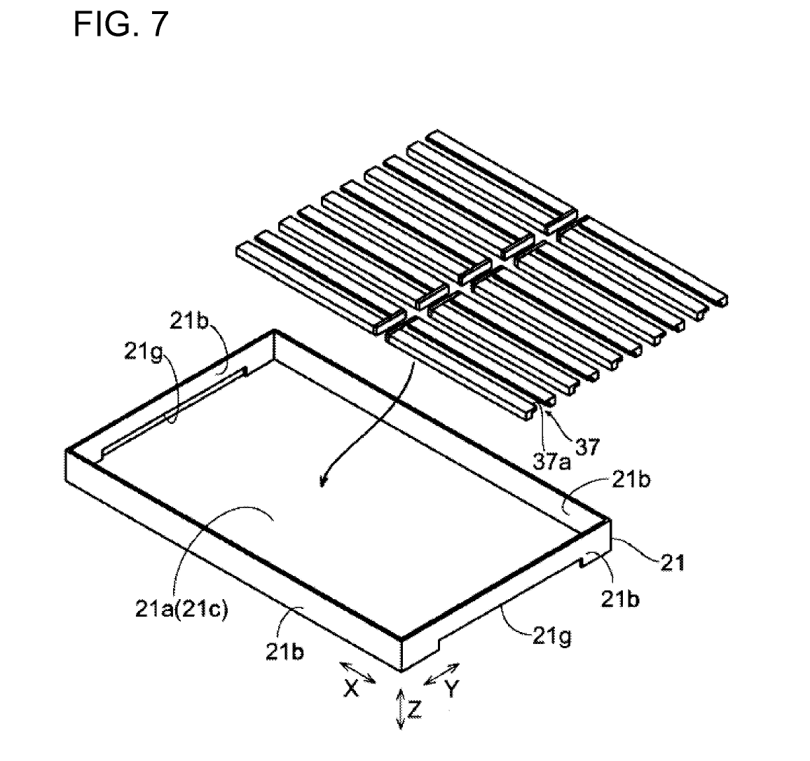

In Embodiment 2, unlike in Embodiment 1, guide grooves 37 as shown in FIG. 7 are attached to a bottom 21a of a back chassis 21 afterwards. Therefore, a structure corresponding to the hole 21e formed in the bottom 21a of the back chassis 21 of Embodiment 1 is not present in the bottom 21a of the back chassis 21 of Embodiment 2.

The guide grooves 37 attached afterwards to the bottom 21a of the back chassis 21 of Embodiment 2 are each constituted of two members having a substantially L shape from a cross-sectional view, and a gap between the two members is a slit 37a. In a part of opposite ends of the bottom 21a of the back chassis 21 in the X direction (opposite sides 21b in the X direction of the back chassis 21), openings 21g for inserting the LED substrates (not shown in drawing) into the guide grooves 37 are formed.

Other configurations of Embodiment 2 are similar to those of Embodiment 1, and detailed descriptions thereof are omitted.

Effects of Embodiment 2 configured in this manner are substantially the same as those of Embodiment 1. However, since guide grooves 37 need to be prepared separately, the number of parts is greater.

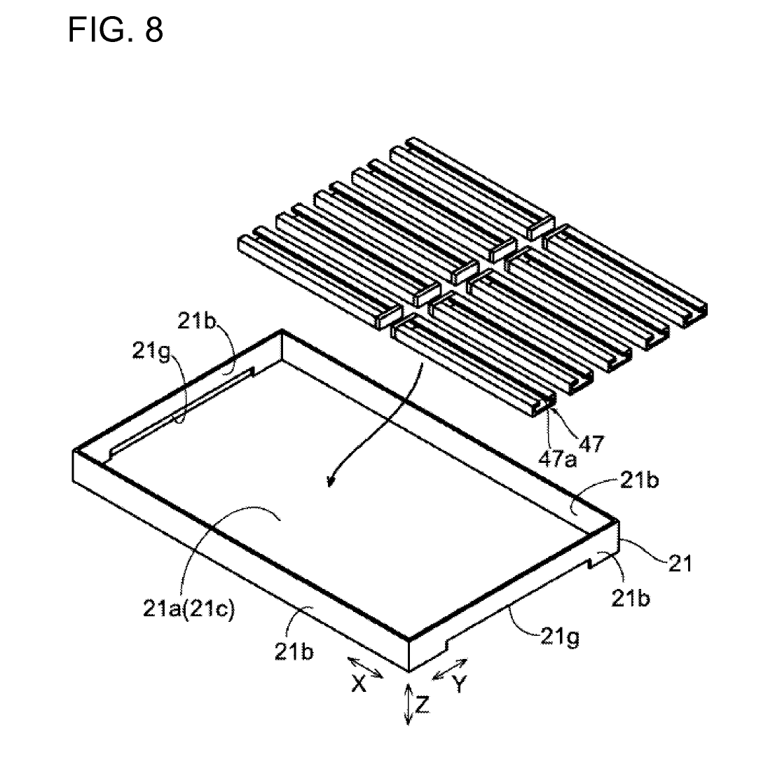

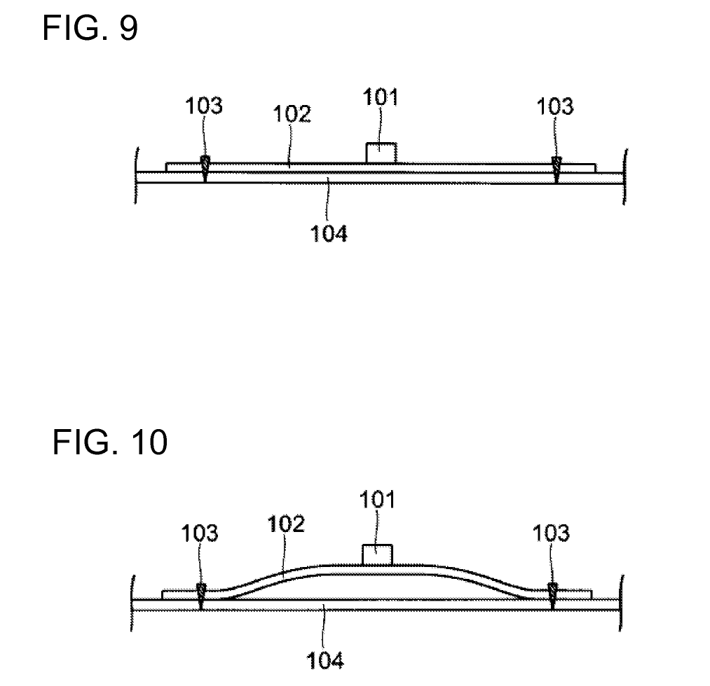

In a configuration of Embodiment 2, as shown in a modification example shown in FIG. 8, guide grooves 47 with a substantially squared-U shape from a cross-sectional view, where respective openings therein are slits 47a, may be attached to the bottom 21a of the back chassis 21 afterwards.

The embodiments disclosed herein are examples in every respect and are not limiting. The scope of the present invention is shown in the claims and not the embodiments described above, and in addition, all modifications within the equivalent meaning and scope of the claims are included.

For example, in the embodiments above, cases in which the present invention is applied to an illumination device disposed in a liquid crystal display device were described, but the present invention is not limited thereto and may be applied to an illumination device disposed in a display device other than a liquid crystal display device.

### DESCRIPTION OF REFERENCE CHARACTERS

10 liquid crystal display panel (display panel)

20 backlight unit (illumination device)

21 back chassis (case)

21a bottom

21c bottom surface

25 LED package (light source)

26 LED substrate (light source substrate)

27, 37, 47 guide groove

27a, 37a, 47a slit

27b edge

27d insertion hole

1. An illumination device, comprising:
a light source substrate on which a light source is mounted; and
a case that has a bottom with a bottom surface facing an object to be illuminated, the case having the light source substrate installed on the bottom thereof,
wherein a rail shaped guide groove having a slit is provided on the bottom of the case, the guide groove extending in a prescribed direction parallel to the bottom surface of the case, and
wherein the light source substrate is inserted in the guide groove, thereby installing the light source substrate on the bottom of the case.

2. The illumination device according to claim 1, wherein the light source substrate is inserted in the guide groove such that the light source protrudes through the slit of the guide groove.

3. The illumination device according to claim 2, wherein a periphery of a part of the light source substrate where the light source is mounted is pressed by edges of the slit of the guide groove.

4. The illumination device according to claim 1, wherein the guide groove extends from one end of the bottom of the case to another end thereof in the prescribed direction.

5. The illumination device according to claim 4, wherein an insertion hole for inserting the light source substrate in the guide groove is provided on an end of the guide groove located on at least one end in the prescribed direction of the bottom of the case.

6. The illumination device according to claim 5, wherein the insertion hole is also provided on an end of the guide groove located on another end in the prescribed direction of the bottom of the case.

7. The illumination device according to claim 5,
wherein a case is disposed such that one end in the prescribed direction of the bottom of the case is located on top and another end in the prescribed direction of the bottom of the case is located on bottom, and
wherein the end of the guide groove located on said another end of the bottom of the case in the prescribed direction is closed.

8. The illumination device according to claim 1, wherein the guide groove is formed integrally on the bottom of the case.

9. A display device, comprising:
the illumination device according to claim 1; and
a display panel illuminated by light from the illumination device.
